(19) United States
(12) Patent Application Publication
(10) Pub. No.: US 2006/0196404 A1
(43) Pub. Date: Sep. 7, 2006

(54) Laminated boat hull and method of manufacturing same

(76) Inventor: George G. Gulden, University Heights, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/367,848

(22) Filed: Mar. 3, 2006

Related U.S. Application Data
(60) Provisional application No. 60/658,306, filed on Mar. 3, 2005.

(51) Int. Cl. B32B 27/38; B32B 27/36; B32B 27/30; B63B 3/00

(52) U.S. Cl. 114/355; 428/522; 428/483; 428/413

(57) ABSTRACT

A laminated boat hull and a method of manufacturing the hull are described wherein the hull includes an outer gel coat layer and a vinyl ester layer chemically bonded to the gel coat layer. The gel coat is preferably a polyester resin material and the vinyl ester layer preferably includes chopped fiberglass which is sprayed onto the gel coat layer. The direct bonding between the gel coat and vinyl ester layers eliminates between said layers a tie coat layer. A layer of epoxy-impregnated fiberglass is chemically bonded to the vinyl ester layer by sanding the vinyl ester layer and washing it with acetone to facilitate the chemical bonding. Additional layers of epoxy-impregnated fiberglass are added to provide desirable strength to the hull.

### CROSS REFERENCE TO RELATED APPLICATIONS

This application claims priority from U.S. Provisional application Ser. No. 60/658,306 filed Mar. 3, 2005; the disclosure of which is incorporated herein by reference.

### BACKGROUND OF THE INVENTION

1. TECHNICAL FIELD

The invention relates generally to boats. More particularly, the invention relates to boat hulls. Specifically, the invention the relates to laminated boat hulls and an improved method of manufacturing said hulls.

2. BACKGROUND INFORMATION

Laminated hulls are well-known in the art of boat building. However, there is always room for improvement with regard to making laminated hulls stronger and more impact resistant. In particular, the various layers making up a laminated hull should be strongly bonded to one another. It is standard within the boating industry to provide a gel coat which forms the outer layer of the laminated hull. The next layer, as one moves inwardly, is referred to in the industry as a “tie coat” in the form of an unsupported spray which is sprayed onto the inner surface of the gel coat. The next layer inward of the tie coat is an epoxy. The tie coat is intended to hold the gel coat and the epoxy coat together. However, the resins of which the tie coat are formed are susceptible to cracking from thermal expansion. This cracking substantially reduces the strength of the laminated hull. The present invention solves this and other problems.

### BRIEF SUMMARY OF THE INVENTION

The present invention provides a laminated boat hull comprising a gel coat layer; and a vinyl ester layer chemically bonded to the gel coat layer.

The present invention also provides a method of manufacturing a laminated hull comprising the steps of forming a hull-shaped gel coat layer; and chemically bonding a vinyl ester layer to the gel coat layer.

### BRIEF DESCRIPTION OF THE SEVERAL VIEWS OF THE DRAWINGS

FIG. 1 is a perspective view of the laminated hull of the present invention as viewed generally from the rear.

FIG. 2 is an enlarged fragmentary view of the inset portion of FIG. 1 showing the various layers forming the laminated hull.

Similar numbers refer to similar parts throughout the specification.

### DETAILED DESCRIPTION OF THE INVENTION

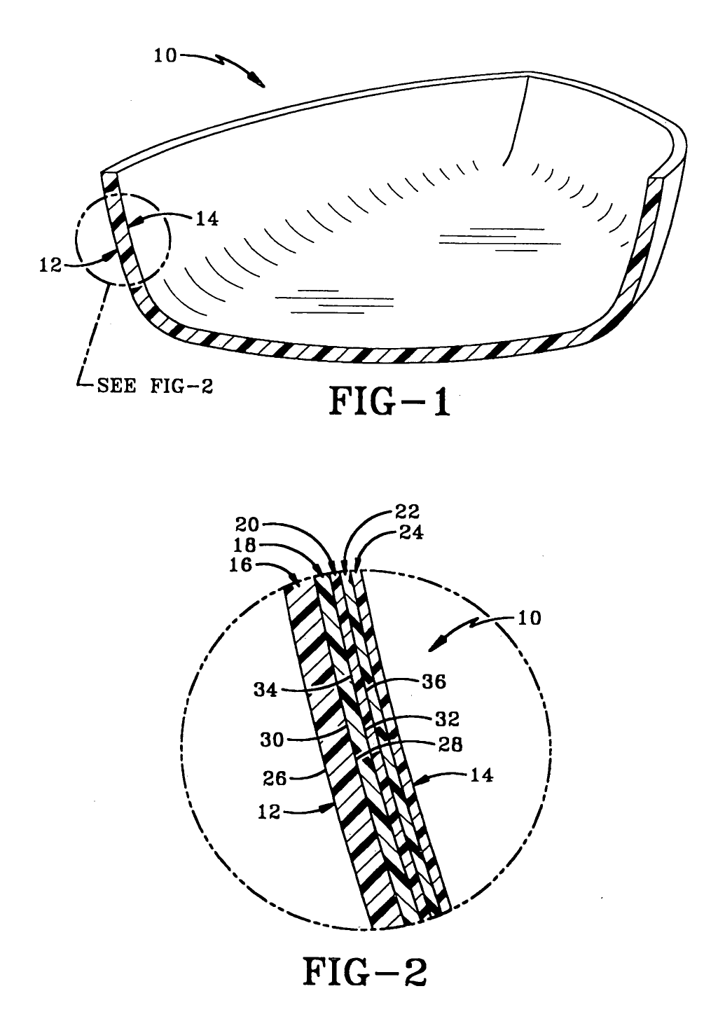

The laminated hull of the present invention is indicated generally at 10 in FIGS. 1-2. Hull 10 has an outer surface 12 and an opposed inner surface 14. Hull 10 includes a plurality of layers including a first layer 16, a second layer 18, a third layer 20, a fourth layer 22, and a fifth layer 24, and may include additional layers. First layer 16 has an outer surface 26 and an opposed inner surface 28. Second layer 18 has an outer surface 30 and an opposed inner surface 32 whereby second layer 18 along outer surface 30 is connected to first layer 16 along inner surface 28. Third layer 20 has an outer surface 34 and an opposed inner surface 36 whereby third layer 20 is connected along outer surface 34 to second layer 18 along inner surface 32. Fourth layer 22 is connected in a similar fashion to third layer 20 and fifth layer 24 is connected in a similar fashion to fourth layer 22. Additional layers are connected likewise.

In accordance with the invention and with reference to FIG. 2, first layer 16 is a gel coat layer and preferably is formed of a polyester resin. Second layer 18 is a modified epoxy in the form of a vinyl ester resin whereby second layer 18 is able to chemically bond or molecularly link to first layer 16 and third layer 20. Thus, hull 10 is free of a layer or any material serving as a connector disposed between first layer 16 and second layer 18. Third layer 20 is formed of epoxy-impregnated fibers which are preferably in the form of fiberglass. The epoxy of third layer 20 is mixed with the hardener and a resin modifier to promote chemical bonding between second layer 18 and third layer 20. The type of epoxy, hardener and resin modifiers may vary. The fiberglass used in third layer 20 is preferably a structural glass cloth although this may vary as well. Subsequent layers of epoxy-impregnated structural glass cloth, such as fourth and fifth layers 22 and 24 are typically added without the resin modifier, as is standard in the industry.

In accordance with the invention, the method of manufacturing laminated hull 10 is described. The gel coat first layer 16 is first formed into the shape of a hull in a manner standard within the art. Typically, this involves spraying a hull mold with the gel coat to form first layer 16. The gel coat is allowed to cure for a desired period of time before application of the vinyl ester material of second layer 20. It is preferred that the gel coat be cured so that it is dry to the touch before applying the vinyl ester material. Typically, this step takes approximately two hours at around 72° F. However, this may vary, and especially with regard to curing at different temperatures. Preferably, the gel coat is allowed to cure no more than four to six hours at the above-noted temperature before application of the vinyl ester material. While the time may vary, especially due to different temperatures, it is important that the curing period for the gel coat not be too long or the vinyl ester material will not be able to chemically bond with the gel coat.

Preferably, the vinyl ester material is mixed with chopped fibers typically in the form of chopped fiberglass. Typically, an applicator gun chops fiberglass, mixes the chopped fiberglass with the vinyl ester material and applies the mixture to the gel coat of first layer 16 in order to form second layer 18. To permit the vinyl ester material to cure, a sufficient amount of the chopped fiberglass or similar material must be used. The fiberglass also provides sufficient thickness for providing a viable second layer 18 to which third layer 20 may be attached. Preferably, at least three ounces of chopped fiberglass is provided for every square foot of second layer 18 in order to provide this sufficient thickness and allow the vinyl ester to cure.

After the vinyl ester has been applied to form second layer 18, air bubbles are removed therefrom. Most commonly, second layer 18 is rolled out to remove the air bubbles, which is typically done with a metal roller having a plurality of annular vanes extending outwardly therefrom to pop and press out the air bubbles, as is standard in the industry. Preferably, the vinyl ester material is cured using a catalyst, many of which are available in the industry. Most preferably, the vinyl ester is cured using a color-changing catalyst whereby the catalyst changes color or the color disappears upon curing of the vinyl ester material to allow for the monitoring of the curing process. While the curing time varies, the vinyl ester is typically allowed to cure for approximately 24 hours at approximately 72° F. The curing time typically is lessened with an increased temperature.

Once the vinyl ester of second layer 18 is sufficiently cured, inner surface 32 of second layer 18 is sanded to remove the surface patina of the cured vinyl ester layer. It has been found, for instance, that a 36-grit five-inch grinderworks well for this purpose. Inner surface 32 is then cleared of dust and washed with acetone or another suitable solvent to promote molecular bonding with third layer 20 once it is applied. In particular, the acetone etches and softens the vinyl ester to a degree sufficient to allow chemical bonding instead of mechanical bonding with third layer 20. In order to take advantage of the condition provided by the acetone wash, the epoxy layup of third layer 20 preferably will begin immediately after the acetone wash. Typically, this means that the application of the third layer 20 should be done within approximately an hour after the acetone wash. While the precise timing may vary, typically if the epoxy of third layer 20 is not applied within approximately one hour, the patina of the vinyl ester of second layer 18 will reappear and thus preclude or substantially reduce the ability of the epoxy of third layer 20 to chemically bond with second layer 18. Once third layer 20 has been applied, any number of subsequent epoxy layers may be applied, as is well known in the art, to provide the desired thickness and strength required for a given laminated hull 10.

Thus, hull 10 and the method of manufacturing hull 10 provide for a laminated hull which is a substantial improvement over the prior art hulls using the “tie coat” between the gel coat layer and the epoxy-impregnated fiberglass layers. As previously noted, such prior art laminated hulls suffer due to the susceptibility of these tie coats to cracking as a result of thermal expansion. The hull of the present invention eliminates this cracking problem altogether and additionally provides a laminated system wherein the vinyl ester second layer 18 is chemically bonded to the gel coat of first layer 16 and also to the epoxy material of third layer 20. The degree of chemical bonding thus provided far exceeds what previously was primarily or substantially mechanical bonding with a minimum amount of chemical bonding. Thus, laminated hull 10 is substantially stronger and less susceptible to deterioration due to thermal expansion than the known prior art laminated hulls.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A laminated boat hull comprising:
a gel coat layer; and
a vinyl ester layer chemically bonded to the gel coat layer.

2. The laminated boat hull of claim 1 wherein the gel coat layer is a polyester resin.

3. The laminated boat hull of claim 1 wherein the vinyl ester layer includes chopped fibers.

4. The laminated boat hull of claim 3 wherein the chopped fibers are fiberglass.

5. The laminated boat hull of claim 1 wherein an epoxy layer is connected to the vinyl ester layer opposite the gel coat layer.

6. The laminated boat hull of claim 5 wherein the epoxy layer includes epoxy-impregnated fibers.

7. The laminated boat hull of claim 5 wherein the vinyl ester layer is chemically bonded to the epoxy layer.

8. The laminated boat hull of claim 5 wherein the gel coat layer is a polyester resin; wherein the vinyl ester layer includes chopped fibers; and wherein the epoxy layer includes epoxy-impregnated fibers.

9. The laminated boat hull of claim 8 wherein the vinyl ester layer is chemically bonded to the epoxy layer.

10. The laminated boat hull of claim 1 wherein the hull is free of a layer disposed between the gel coat layer and the vinyl ester layer.

11. A method of manufacturing a laminated hull comprising the steps of:
forming a hull-shaped gel coat layer; and
chemically bonding a vinyl ester layer to the gel coat layer.

12. The method of claim 11 wherein the step of chemically bonding includes the step of chemically bonding a vinyl ester layer including chopped fibers to the gel coat layer.

13. The method of claim 12 further including the step of connecting an epoxy layer to the vinyl ester layer opposite the gel coat layer.

14. The method of claim 13 wherein the step of connecting includes the step of chemically bonding the epoxy layer to the vinyl ester layer.

15. The method of claim 14 further including the step of applying a solvent to the vinyl ester layer to facilitate chemical bonding between the epoxy layer and the vinyl ester layer.

16. The method of claim 15 wherein the step of applying includes applying acetone to the vinyl ester layer.

17. The method of claim 15 further including the step of sanding the vinyl ester layer prior to applying the solvent.

18. The method of claim 12 further including the step of chemically bonding a layer comprising epoxy-impregnated fibers to the vinyl ester layer opposite the gel coat layer.

19. The method of claim 18 further including the steps of sanding the vinyl ester layer and subsequently applying acetone to the vinyl ester layer to facilitate chemical bonding between the layer comprising epoxy-impregnated fibers and the vinyl ester layer.

20. The method of claim 11 wherein the step of chemically bonding includes the step of chemically bonding the vinyl ester layer to the gel coat layer without placing a layer between the vinyl ester and gel coat layers.
